(19) United States
(12) Patent Application Publication
(10) Pub. No.: US 2005/0076071 A1
(43) Pub. Date: Apr. 7, 2005

(54) Ordering by hamming value

(76) Inventors: Douglas B King, Lancashire (GB); James R Armstrong, Lancashire (GB)

Correspondence Address: NIXON & VANDERHYE, PC, 1100 N GLEBE ROAD, 8TH FLOOR, ARLINGTON, VA, 22201-4714, US

(21) Appl. No.: 10/475,760

(22) PCT Filed: Feb. 21, 2003
(86) PCT No.: PCT/GB03/00756

(30) Foreign Application Priority Data
Feb. 25, 2002 (GB) 0204412.1

(51) Int. Cl. G06F 7/00

(52) U.S. Cl. 708/202

(57) ABSTRACT

Apparatus and methods are disclosed for treating an input set of weightless binary tuples to order the Hamming values thereof. In the general case, the tuples are thermometer coded in a common direction (left or right) and thereafter an orthogonal thermocoding operation is applied in which orthogonal tuples, each taking a bit from a respective bit position of the thermocoded tuples, is subjected to a thermocoding operation in a common direction (up or down). At the completion of this operation the tuples represent the Hamming values of the input tuples, ranked in Hamming value order. The first thermocoding operation may be omitted where the input tuples are already in thermometer code. Also described is a scheme, which uses a tagging procedure to give the result in terms of the original weightless binary tuples, whereby the input pattern information is preserved.

This invention relates to apparatus and methods for ordering the Hamming values (as herein defined) of a set of weightless binary tuples, and to filter apparatus utilising such apparatus and methods.

There are many applications where it is required to order the Hamming values of an input set of weightless binary tuples (as herein defined), for example to determine a median Hamming value for a set of weightless binary tuples (otherwise referred to as a “weightless median”) or either or both of the outlier Hamming values (otherwise referred to as “weightless outliers”). For example in a digital signal filtering operation it is known to define a rolling window of defined extent which operates on a stream of digital samples, and to replace each value with a filtered value determined by a collective property of the values in the window, typically a mean or a median value, such as a weightless median. There are other instances where the outlier values may be required, for example as a measure or metric of the homogeneity of the samples in the window.

Other instances where ordering of the Hamming values and/or determination of a weightless median and/or the weightless outliers may be required is in error detection and correction of digital code.

It may be required to determine a generic template from a set of exemplars, and the weightless median of the exemplars could be used as the generic template.

One possible way of extracting the weightless median would be to use a traditional algorithmic processor to evaluate the Hamming values and order the tuples thereby to extract the weightless median. This may be suitable for some applications, but for operation in some harsh cosmic environments an asynchronous, memoryless, clockless implementation is desirable in order to reduce cosmic induced bit errors.

Definitions

Weightless binary: This means that each active bit has unit weight—just “1” as opposed to “natural” weighted binary which has positional weightings of 1, 2, 4, 8 . . . .

Weightless binary tuple: This defines a collection of weightless bits in which the order is irrelevant. For example, [0 0 1 1], [1 1 0 0] and [1 0 1 0] each have the same significance.

Thermometer code (alternatively referred to as thermocode): This is a form of weightless binary in which the 1's and 0's within the tuple are grouped together. For example, [1 0 1 0 1] in thermocode is [1 1 1 0 0] or, alternatively, [0 0 1 1 1].

Hamming value (Hv): This is the number of 1's within a tuple. For example [1 0 1 0 1 1] has a Hamming value of 4.

Traditional median: Given an odd number of values the median is the central value of the ordered set. For example given [3 1 2 4 7], they are ordered as [1 2 3 4 7]. The central value, the median, is 3.

Outliers: Given a set of values, the outliers are the extreme values of the ordered set. For example given [27 3 1 2 4 7], they are ordered as [1 2 3 4 7 27]. The outliers are 1 and 27.

Weightless median: Given an odd number of weightless tuples the weightless median is the Hamming value of the central tuple of the set ordered by Hamming value. If there is an even number of weightless tuples the weightless median may be taken to be either of the values to either side of the non-existent median and this is still referred to herein as a weightless median. Thus for an even number of weightless tuples the weightless median may not be a unique value. Alternatively, the set may be made up to an odd number by duplication of one of the tuples. The resultant weightless median is likewise also referred to as a weightless median.

Weightless outlier: Given any number of weightless tuples the weightless outliers are the Hamming values of the extreme tuples of the set ordered by Hamming value.

For example, given 5 weightless tuples, t1 to t5;

$$\begin{matrix}t1 = [ \begin{matrix}0 & 0 & 1 & 0 & 0 & 0\end{matrix} ] , & Hv = 1 lowest \\ t2 = [ \begin{matrix}1 & 0 & 0 & 1 & 0 & 0\end{matrix} ] , & Hv = 2 \\ t3 = [ \begin{matrix}0 & 0 & 1 & 0 & 0 & 0\end{matrix} ] , & Hv = 1 ( equal lowest ) \\ t4 = [ \begin{matrix}0 & 0 & 1 & 1 & 0 & 1\end{matrix} ] , & Hv = 3 highest \\ t5 = [ \begin{matrix}1 & 1 & 0 & 0 & 0 & 0\end{matrix} ] , & Hv = 2\end{matrix}$$

Ordering these tuples according to their Hamming value gives;

$$\begin{matrix}t4 = [ \begin{matrix}0 & 0 & 1 & 1 & 0 & 1\end{matrix} ] , & Hv = 3 Highest outlier \\ t2 = [ \begin{matrix}1 & 0 & 0 & 1 & 0 & 0\end{matrix} ] , & Hv = 2 \\ t5 = [ \begin{matrix}1 & 1 & 0 & 0 & 0 & 0\end{matrix} ] , & Hv = 2 Weightless median \\ t3 = [ \begin{matrix}0 & 0 & 1 & 0 & 0 & 0\end{matrix} ] , & Hv = 1 \\ t1 = [ \begin{matrix}0 & 0 & 1 & 0 & 0 & 0\end{matrix} ] , & Hv = 1 Lowest outlier\end{matrix}$$

Hence the Hamming value of t5, or t2, is the weightless median but given in thermometer code. The selection of the Hamming value of t5 or t2 as the weightless median is unimportant.

### SUMMARY OF THE INVENTION

According to one aspect of this invention there is provided a method of treating an input set of weightless binary thermometer code tuples each with the set bits grouped at a given end of each tuple, to order the Hamming values of said weightless binary thermometer code tuples, which comprises performing an orthogonal thermocoding operation equal or corresponding to one in which:
(i) the set of weightless binary thermometer code tuples is assembled into a matrix with said weightless binary tuples stacked in a given direction (e.g. vertically) to define a set of orthogonal tuples each extending in said given direction (e.g. vertically) and each made up of a bit taken from each of said weightless binary tuples at a respective bit position, and
(ii) each of said orthogonal tuples is subjected to a thermocoding step to group the set bits at a given end of each tuple,

thereby to order the Hamming values of said weightless binary thermometer code tuples.

The orthogonal thermocoding operation may be performed in various different ways as to be described below and it is not essential for the weightless binary thermometer code tuples actually to be assembled into a matrix provided that an analogous thermocoding operation is achieved. Surprisingly, we have found that performing an orthogonal thermocoding operation on an input set of weightless binary thermometer code tuples orders the Hamming values of the tuples without altering the Hamming values.

If the input data is not already in the form of weightless binary thermometer code tuples then there may be appropriate encoding and decoding upstream and downstream of the orthogonal thermocoding operation to convert input data (e.g. weighted binary, weightless binary etc.) into thermometer code and to return it to the desired coding.

Accordingly, in another aspect, where the input is in the form of weightless binary tuples, this invention provides a method of treating an input set of weightless binary tuples to order the Hamming values of said weightless binary tuples, which comprises performing a thermocoding operation on each of said weightless binary tuples to group the set bits at a given end of each tuple to provide a set of weightless binary thermometer code tuples, and thereafter performing an orthogonal thermocoding operation corresponding to one in which:
(i) the set of weightless binary thermometer code tuples is assembled into a matrix with said weightless binary tuples stacked in a given direction (e.g. vertically) to define a set of orthogonal tuples each extending in said given direction (e.g. vertically) and each made up of a bit taken from each of said weightless binary tuples at a respective bit position, and
(ii) each of said orthogonal tuples is subjected to a thermocoding step to group the set bits at a given end of each tuple,
thereby to order the Hamming values of said weightless binary tuples.

Having ordered the set of Hamming values one or more selected Hamming values of the set may be determined. For example, where the input set comprises an odd number of tuples a weightless median of said set may be determined by identifying the central value of the ordered set. Where the input set comprises an even number (2n) of tuples, a median may be determined by identifying in the ordered set a value corresponding to the n^{th} or the n+1^{th} value. Alternatively, where the input set comprises an even number of tuples, a further tuple may be introduced into the set (for example by duplicating one of the other tuples of the input set) to make an odd number of tuples before performing the orthogonal thermocoding operation.

At least one weightless outlier value may be determined by identifying at least one of the first and last of said ordered Hamming values.

Where the input bit pattern corresponding to one of the ordered Hamming values is required, in one embodiment having ordered the Hamming values of said weightless binary tuples, and after said orthogonal thermocoding operation, the bit pattern of at least one of said tuples corresponding to a given ranking is compared to the bit patterns of the tuples before said orthogonal thermocoding operation to identify an or the equivalent tuple thereto, and the location of said equivalent tuple is used to determine a corresponding input tuple, thereby to identify or present the input tuple with said given ranking.

The invention extends to a method of applying a filtering operation to a two- or—higher dimensional array of tuples in which the method as defined above is performed on a set of values in a pre-determined window in said array in a filtering step and at least a selected one of the ordered Hamming values is used as the filtered result, with the window being incremented relative to the array to provide a series of filtered results.

In one instance, a median Hamming value is taken as the filtered result.

The filtering operation may be applied to a two-dimensional array of tuples, for example representing a two-dimensional image. Alternatively, the filtering operation may be applied to a three-dimensional array of tuples, representing a three-dimensional volume of air traffic space.

The invention also extends to filter apparatus for applying the filtering operation described above.

In another aspect, this invention provides apparatus for treating an input set of weightless binary thermometer code tuples with the set bits grouped at a given end of each tuple, thereby to order the Hamming value of said weightless binary thermometer code tuples, said apparatus comprising:
transformation means for performing an orthogonal thermocoding operation corresponding to one in which:
(i) the set of weightless binary thermometer code tuples is assembled into a matrix with said weightless binary tuples stacked in a given direction (e.g. vertically) to define a set of orthogonal tuples each extending in said given direction (e.g. vertically) and each made up of a bit taken from each of said weightless binary tuples at a respective bit position, and
(ii) each of said orthogonal tuples is subjected to a thermocoding step to group the set bits at a given end of each tuple,
thereby to order the Hamming values of said weightless binary thermometer code tuples.

The above apparatus is intended to receive an input set of weightless binary tuples in thermometer code.

In another aspect, intended for treating an input set of weightless binary tuples not already in thermometer code, there is provided apparatus for treating an input set of weightless binary tuples, which comprises:
first stage thermocode converter means for converting each of said weightless binary tuples into a weightless binary thermometer code tuple to provide a set thereof, and
transformation means for performing an orthogonal thermocoding operation corresponding to one in which:
(i) the set of weightless binary thermometer code tuples is assembled into a matrix with said weightless binary tuples stacked in a given direction (e.g. vertically) to define a set of orthogonal tuples each extending in said given direction (e.g. vertically) and each made up of a bit taken from each of said weightless binary tuples at a respective given bit position, and
(ii) each of said orthogonal tuples is subjected to a thermocoding step to group the set bits at a given end of each tuple,
thereby to order the Hamming values of said weightless binary thermometer code tuples.

Preferably, the first stage thermocode converter means comprises respective thermocode converter means for each of said weightless binary tuples making up the input set.

The transformation means preferably includes orthogonal tuple defining means for defining a set of orthogonal tuples, each said orthogonal tuple being made up of bits taken from a respective bit position of said weightless binary thermometer code tuples, and respective thermocode converter means for thermocoding each of said orthogonal tuples. The orthogonal tuple defining means typically comprises a mapping of interconnects mapping the bits of the thermometer code tuples to the appropriate thermocode converter means.

Preferably, said apparatus includes means for analysing a matrix made up of said thermocoded orthogonal tuples to determine the or a central tuple orthogonal to said orthogonal tuples, said central tuple representing to the median Hamming value of said weightless binary thermometer code tuples. Likewise the apparatus may include means for determining the first and the last of the tuples orthogonal to said orthogonal tuples, representing at least one outlier.

The thermocode means may take many forms. For example it may comprise an asynchronous thermometer coding means using a modular structure. Alternatively, at least one of the thermocode means may comprise a pipelined synchronous thermocode means. Examples of such devices are given in our earlier published International Patent Application No. WO 99/33184. Yet further, the thermocode converter means may comprise a thermometer code converter which operates on an input stream of weightless binary data, as described in our copending application of even date Patent Application No. PCT/GB03/______(our reference XA1619).

In another aspect, this invention provides apparatus for treating an input set of weightless binary thermometer code tuples each with the set bits grouped at a given end of the tuple, said apparatus comprising:
respective thermocode converter means for each bit position of the input tuples, each thermocode converter means receiving a bit from each of the weightless binary thermometer code tuples and performing a thermometer coding operation on said bits, collectively to apply an orthogonal coding operation on said weightless binary tuple code tuples, to provide a set of orthogonally thermocoded tuples, which when assembled side-by-side in a matrix make up an ordered set of tuples representing the Hamming values of said weightless binary thermometer code tuples.

In yet another aspect this invention provides apparatus for treating an input set of weightless binary tuples which comprises:—
respective first stage thermocode converter means for converting each of said weightless binary tuples into a weightless binary thermometer code tuple;
respective second stage thermocode converter means for each bit position of the input tuples, each thermocode converter means receiving a bit from each of the weightless binary thermometer code tuples and performing a thermometer coding operation on said bits, collectively to apply an orthogonal coding operation on said weightless binary tuple code tuples, to provide a set of orthogonally thermocoded tuples, which when assembled in a matrix make up an ordered set of tuples representing the Hamming value of said weightless binary thermometer code tuples.

Whilst the invention has been described above, it extends to any inventive combination of the features set out above or in the following description.

The invention may be performed in various ways, and an embodiment thereof will now be described by way of example-only, reference being made to the accompanying drawings, in which:—

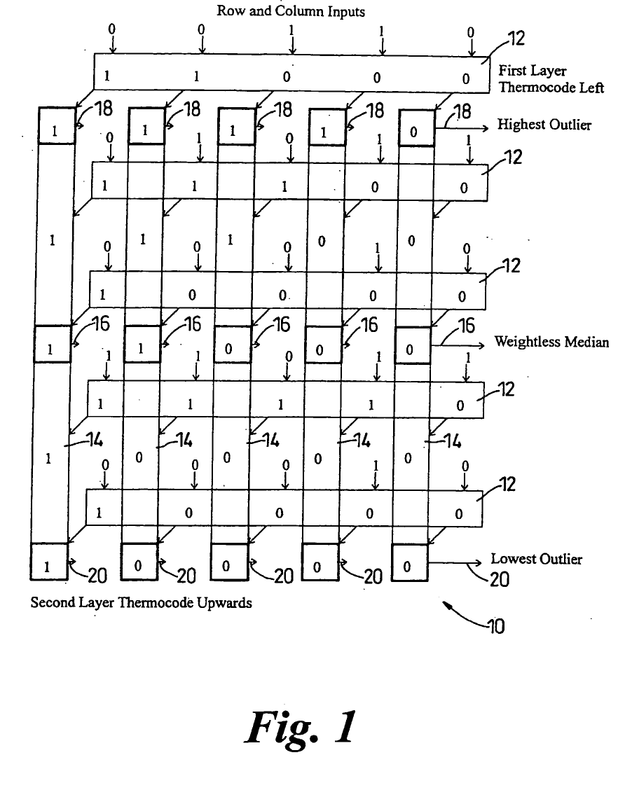

FIG. 1 is a schematic view of a first embodiment of a weightless median evaluator in accordance with this invention;

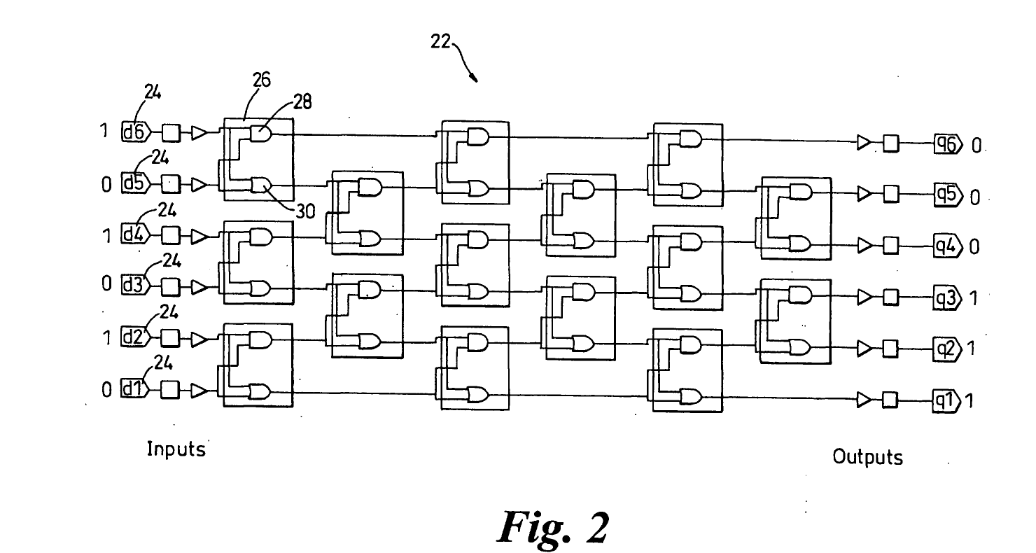

FIG. 2 is an example of a known thermometer code converter of modular form for use as a component in the embodiment of FIG. 1;

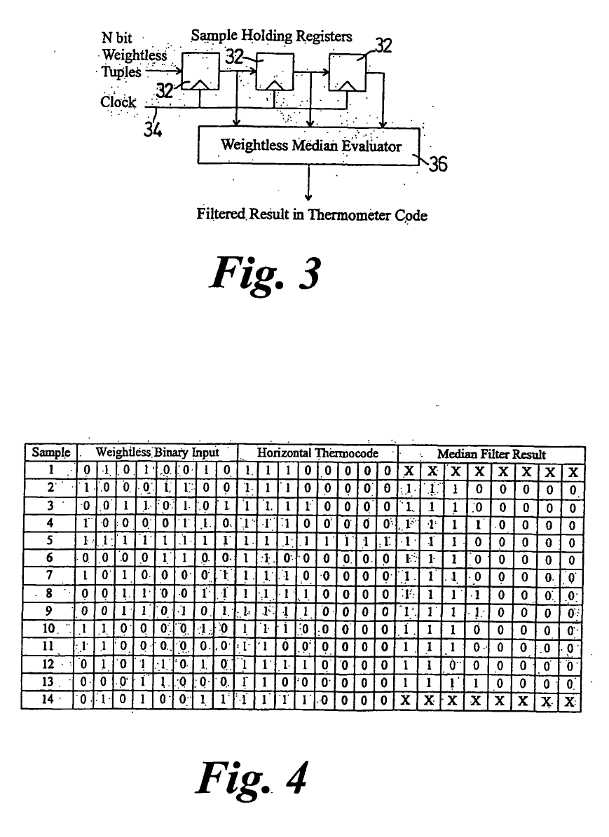

FIG. 3 is a schematic diagram of a weightless median filter in accordance with the invention and using a weightless median evaluator of the form shown in FIG. 1;

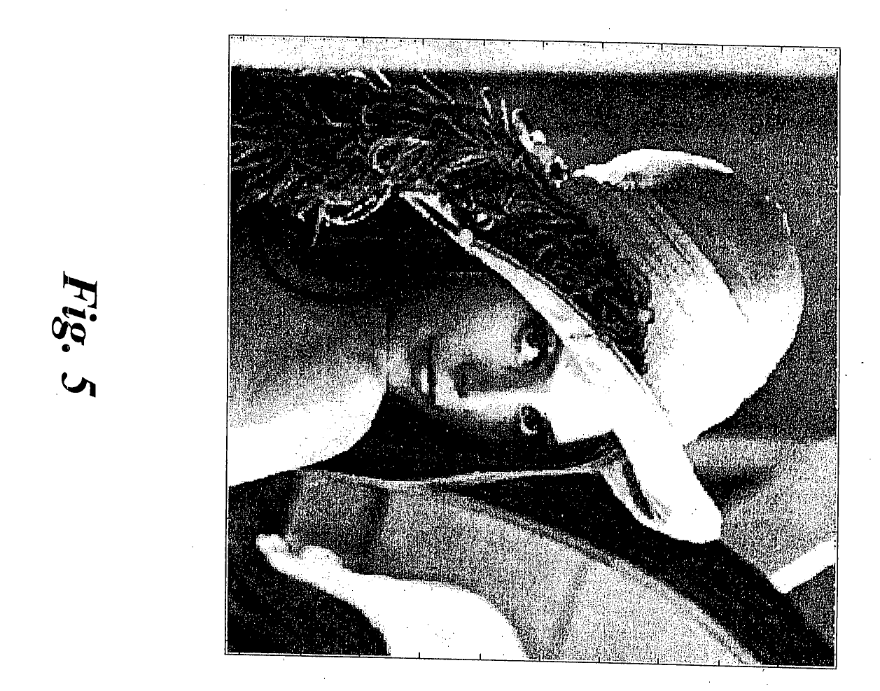

FIG. 4 is a chart showing the weightless binary inputs, the results of a first stage horizontal thermocode conversion and the median filter result for a series of samples 8 bits wide and with a window size of three successive samples;

FIG. 5 is a reference image (512×512 pixel 8 bit weighted grey-scale);

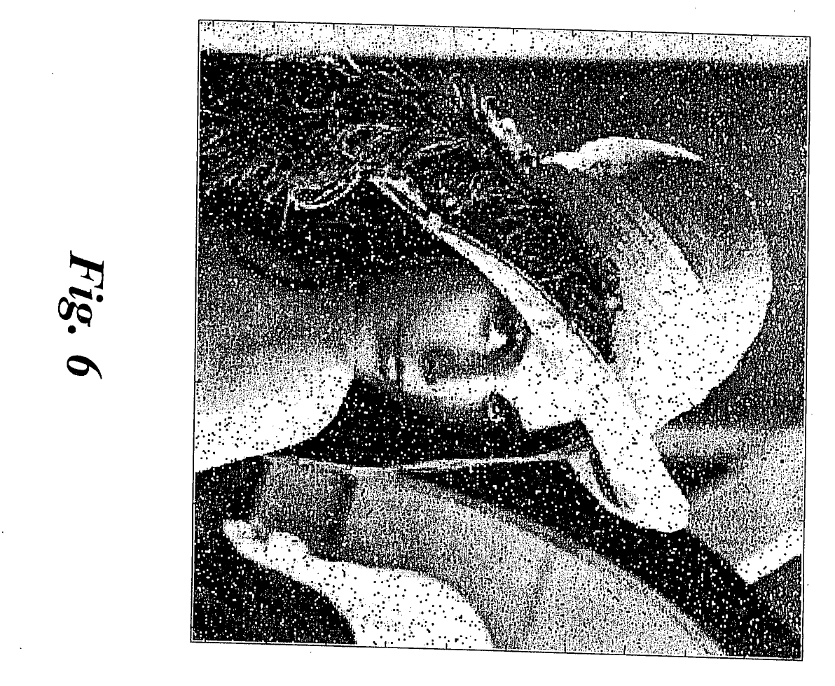

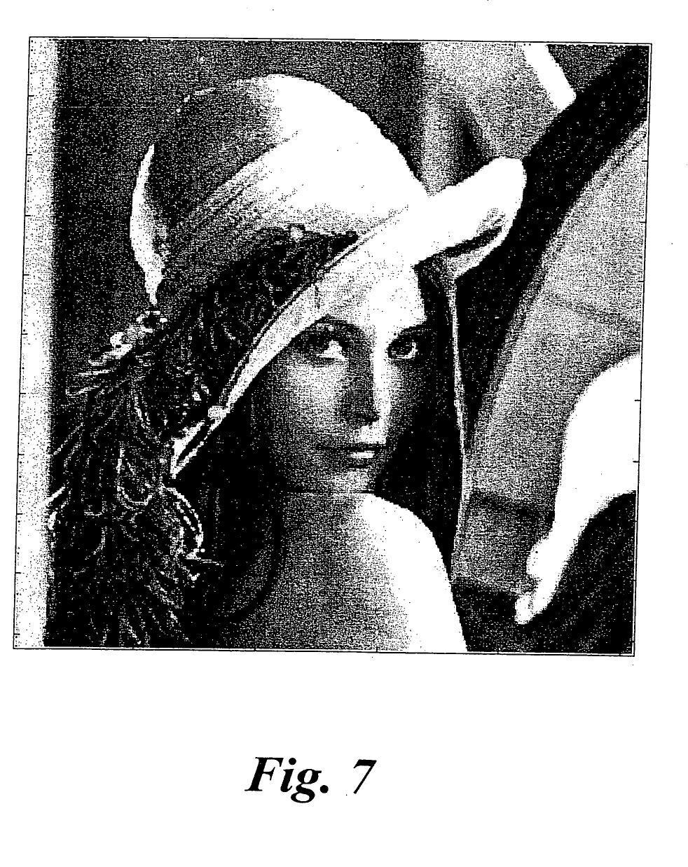

FIG. 6 is the image of FIG. 5 but with 10% added salt-and-pepper noise;

FIG. 7 is the image of FIG. 5 using the weightless median filter, and

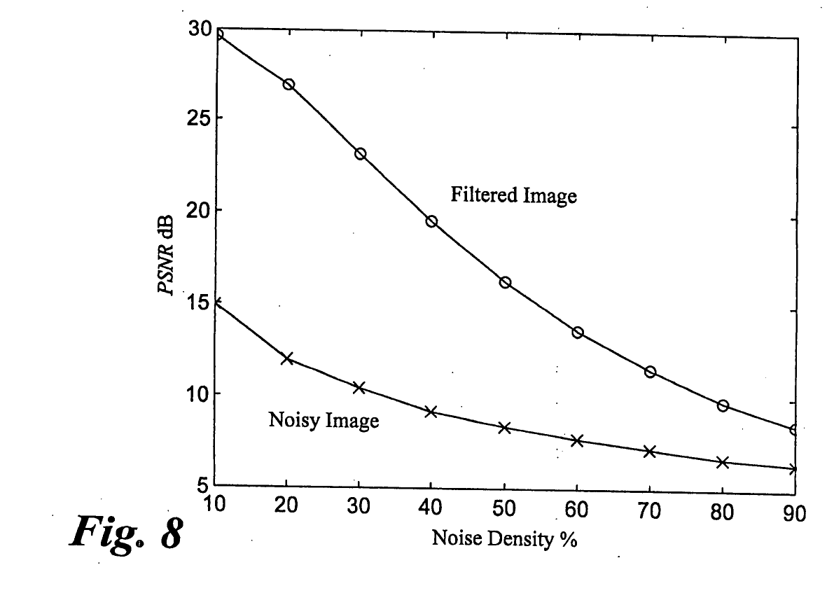

FIG. 8 is a graph showing the trend in filtration improvement as the noise density is increased.

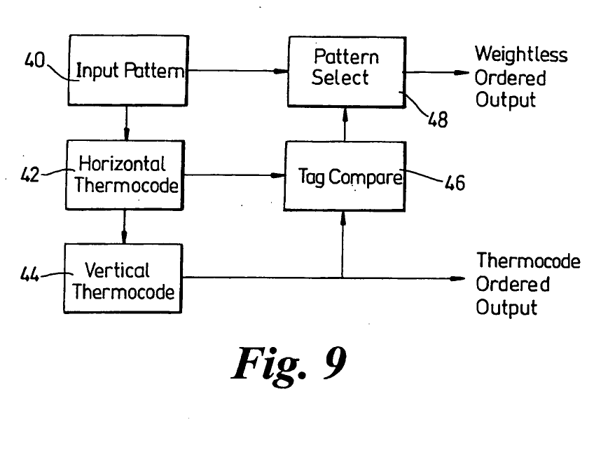

FIG. 9 is a top level block diagram of a second embodiment in accordance with this invention, which orders a set of weightless binary tuples according to their Hamming value, and

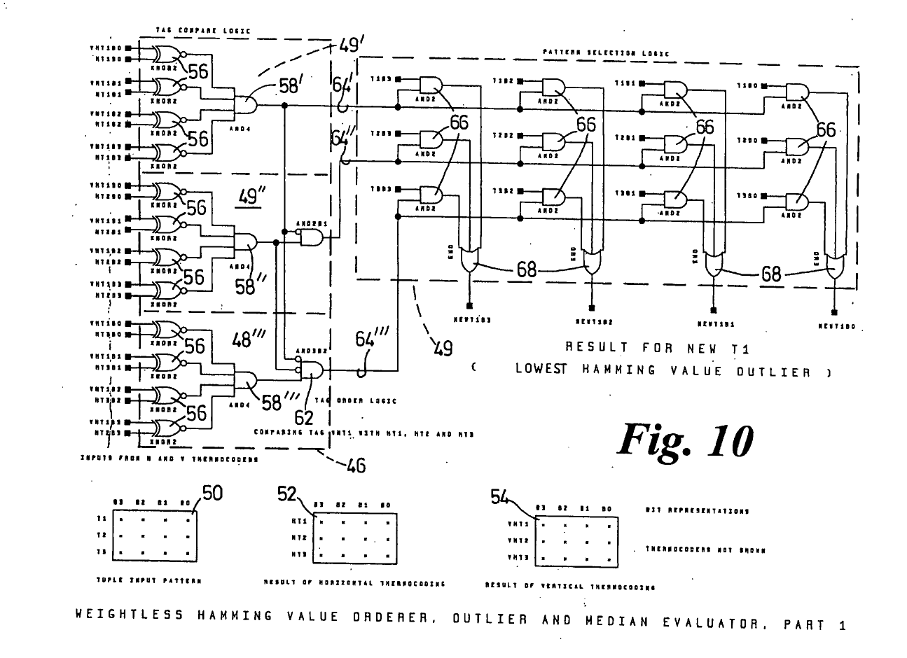

FIGS. 10 to 12 are logic diagrams of Boolean logic implementations of the tag compare modules and the pattern select module of the second embodiment.

The embodiments disclosed herein describe a new mechanism for Hamming value ordering and weightless median extraction from a set of weightless binary tuples. Obviously the input data needs to be converted into weightless binary if it is not already in this form. Initially the bit manipulation steps performed to achieve Hamming value ordering and weightless median extraction will be described with reference to the five weightless tuples t1 to t5, each 6 bits wide, described in the introduction, on pages 3 and 4 of the text as filed. Having described the bit manipulation steps required apparatus for implementing the invention will be described in further detail.

Given the earlier example of,

$$\begin{matrix}t1 = [ \begin{matrix}0 & 0 & 1 & 0 & 0 & 0\end{matrix} ] \\ t2 = [ \begin{matrix}1 & 0 & 0 & 1 & 0 & 0\end{matrix} ] \\ t3 = [ \begin{matrix}0 & 0 & 1 & 0 & 0 & 0\end{matrix} ] \\ t4 = [ \begin{matrix}0 & 0 & 1 & 1 & 0 & 1\end{matrix} ] \\ t5 = [ \begin{matrix}1 & 1 & 0 & 0 & 0 & 0\end{matrix} ] \\ \begin{matrix} c1 & c2 & c3 & c4 & c5 & c6\end{matrix}\end{matrix}$$

t1 to t5 are the input tuples, and columns c1 to c6 are imposed orthogonal thermocoding is now performed; in a first stage, each tuple t1 to t5 is thermocoded. So the rows t1 to t5 are thermocoded in either direction—to the left or the right. This gives, thermocoding to the left,

$$\begin{matrix}[ \begin{matrix}1 & 0 & 0 & 0 & 0 & 0\end{matrix} ] \\ [ \begin{matrix}1 & 1 & 0 & 0 & 0 & 0\end{matrix} ] \\ [ \begin{matrix}1 & 0 & 0 & 0 & 0 & 0\end{matrix} ] \\ [ \begin{matrix}1 & 1 & 1 & 0 & 0 & 0\end{matrix} ] \\ [ \begin{matrix}1 & 1 & 0 & 0 & 0 & 0\end{matrix} ]\end{matrix}$$

Then thermocoding is performed along the columns, either upwards or downwards. This gives, thermocoding upwards, the desired result:—

$$\begin{matrix}[ \begin{matrix}1 & 1 & 1 & 0 & 0 & 0\end{matrix} ] & Highest weightless outlier \\ [ \begin{matrix}1 & 1 & 0 & 0 & 0 & 0\end{matrix} ] & \\ [ \begin{matrix}1 & 1 & 0 & 0 & 0 & 0\end{matrix} ] & Weightless median \\ [ \begin{matrix}1 & 0 & 0 & 0 & 0 & 0\end{matrix} ] & \\ [ \begin{matrix}1 & 0 & 0 & 0 & 0 & 0\end{matrix} ] & Lowest weightless outlier\end{matrix}$$

The orthogonal thermocoding process yields the weightless median in thermocode as the central value i.e. row t5.

This process may be visualised as assembling the input tuples into a matrix, then performing a first thermocoding step in which each tuple is thermocoded along the rows to the left, and a second thermocoding step in which the columns are thermocoded upwards. In this visualisation the tuples could be stacked vertically or horizontally, provided the first thermocoding is done in one sense along the direction of the tuples. In practice of course there may be no matrix as such because the tuples may be supplied to individual first stage thermocoders whose outputs are hardwired in a preset mapping to the inputs of individual second stage thermocoders, with selected outputs of the second stage thermocoders hardwired to an output interface.

It should be noted that, in the described embodiment, the two stage orthogonal process must be performed in order, namely a horizontal operation along the direction of the tuple and then a vertical operation orthogonal thereto.

Naturally if the input data is already thermocoded it is only required to perform the vertical thermocoding to obtain the weightless median. It will be appreciated that this provides a unique weightless median only if there is an odd number of tuples. When presented with an even set of tuples, one of the tuples (for example, the first) is duplicated to obtain an odd set. Alternatively the tuple one above or below the non-existent median may be taken as an approximation; such an approximation obtained in either manner is also referred to herein for convenience as a weightless median.

The above method is technology independent; it may be implemented electronically, optically, magnetically etc.

Referring now to FIG. 1, this shows a block diagram for a weightless median evaluator which also determines the weightless outliers.

Referring to the Figure, the weightless median evaluator 10 is designed to receive and evaluate the median of 5, 5-bit wide weightless binary tuples. The evaluator 10 comprises a first layer of thermocoders 12 designed to thermocode to the left, i.e. to group the set bits at the left hand end of the thermocode output. The inputs to each first layer thermocoder are here shown above the thermocoder box, whilst the thermocode output is shown within the box.

An orthogonal set of five second layer thermocoders 14 receives as inputs the outputs of the first layer of thermocoders 12. Each second layer thermocoder 14 takes the output bits from a respective bit position of the thermocoded output of the first layer; thus the leftmost second layer thermocoder 14 takes the leftmost bits of the thermocode output of the first layer of thermocoders, the rightmost second layer thermocoder 14 takes the rightmost bits of the thermocoded output of the first layer and so on. Thus if the five input tuples (0 0 1 1 0), (0 1 0 1 1), (0 0 0 1 0), (1 1 0 1 1) and (0 0 0 1 0) are visualised as a matrix made up of these tuples stacked vertically, thus

$$\begin{matrix}0 & 0 & 1 & 1 & 0 \\ 0 & 1 & 0 & 1 & 1 \\ 0 & 0 & 0 & 1 & 0 \\ 1 & 1 & 0 & 1 & 1 \\ 0 & 0 & 0 & 1 & 0\end{matrix}$$

the first layer of thermocoders thermocode the rows to the left, to provide the following array:

$$\begin{matrix}1 & 1 & 0 & 0 & 0 \\ 1 & 1 & 1 & 0 & 0 \\ 1 & 0 & 0 & 0 & 0 \\ 1 & 1 & 1 & 1 & 0 \\ 1 & 0 & 0 & 0 & 0\end{matrix}$$

the orthogonal thermocoding operation effects the transformation to the following:

$$\begin{matrix}1 & 1 & 1 & 1 & 0 \\ 1 & 1 & 1 & 0 & 0 \\ 1 & 1 & 0 & 0 & 0 \\ 1 & 0 & 0 & 0 & 0 \\ 1 & 0 & 0 & 0 & 0\end{matrix}$$

Referring back to FIG. 1, the central output bit of each second layer thermocoder is output as a tuple at 16 to represent the weightless median. Likewise the first and last bits from each of the second layer thermocoders may be output at 18 and 20 respectively to indicate the highest and lowest outliers.

FIG. 2 is a diagram representing a suitable form of asynchronous modular thermometer coder 22 which could be used to implement the arrangement of FIG. 1. Five such decoders would be required in the first layer and five in the second layer. The thermometer code converter of FIG. 2 has six inputs 24 but the sixth input could be set at zero in each case. The decoder of FIG. 2 is described in more detail in International Published Application WO 99/33184 but briefly is made up of a series of interconnected modules or “bit manipulation cells” 26 each made up of an AND gate 28 and an OR gate 30 interconnected as shown in the Figure. It is emphasised that this is just one form of thermometer code converter and many others may be used.

The orthogonal median evaluator of FIG. 1 may be used to form a weightless median filter as shown in FIG. 3. In the arrangement of FIG. 3 a stream of n-bit weightless tuples is supplied to a chain of three sample holding registers 32 through which the samples are clocked under the control of a clock 34. The chain is tapped and three samples are provided to a weightless median evaluator 36. The sample holding registers 32 effectively define a rolling three sample window which supplies three weightless samples at each clock cycle. Here the weightless evaluator 36 has a first layer of three thermocode generators (one for each sample) (not shown) with each first layer thermocode generator being n bits wide. The second layer will have n thermocode generators (not shown) each three bits wide.

FIG. 4 shows a series of 14 input samples (labelled “Weightless Binary Input”), the result of the first thermocode conversion (labelled “Horizontal Thermocode”) and the median filter result output defined by the tuple made up from the output bits at the centre bit position of each of the n second level thermocode generators. In particular it will be noted that the potentially suspect sample 5 has been attenuated in the filtered output.

In another example, a MATLAB® simulation of a two-dimensional, three-by-three sample space (defining a nine-element “window”) operated on the same principles as the block diagram shown in FIG. 3. The nine-element window is set up in known fashion using line delays and sample holding registers controlled by a clock signal to make available the current nine samples to a weightless median evaluator. In this example, a test image consisting of a 512×512 pixel 8-bit weighted grey-scale image was used as a reference. The 8-bit binary code converts into 255 bits of thermometer code. Quantisation noise was excluded from the simulation. As before, the number of thermocoders in the first stage is dictated by the number of samples in the window (i.e. nine) with the number of second stage orthogonal thermometer code converters corresponding to the digital width of the samples.

FIG. 5 is a representation of the image used in this example, before the addition of noise. A noise density of 10% was used to add impulsive salt-and-pepper noise to the reference image to form a suitable image for processing using the weightless median filter.

FIG. 6 shows the image with the noise added. The mean square error introduced by the noise was 2121 and the peak signal-to-noise ratio was 14.9 dB.

The filtered image is shown in FIG. 7. The mean square error has been reduced by the filtration to 71 and the peak signal-to-noise ratio has increased to 29.6 dB.

FIG. 8 shows the trend in filtration improvement as the noise densities increase.

The embodiment of FIG. 1 provides an ordered set of tuples which are thermocoded versions of the input tuples rather than the tuples themselves. Whilst this is useful in many applications such as the median filter illustrated in FIG. 3, there are other applications in which it is desirable to output, say, the actual tuple having the median value in a set, rather than a thermocoded version thereof.

Accordingly, the further embodiment illustrated and described with reference to FIGS. 9 to 12 receives a set of weightless binary input tuples and uses a technique similar to the above technique of orthogonal thermocoding to order thermocoded versions of the input tuples, but with a modification to give the result in terms of the original weightless binary tuples whereby the input pattern information is preserved.

FIG. 9 is a top level block diagram of this further embodiment, which will be described in conjunction with a worked example. The input pattern, which in this example is three input tuples T1 to T3, e.g.

$$\begin{matrix}T1 & & 0 & 1 & 0 & 1 \\ T2 & & 0 & 1 & 0 & 0 \\ T3 & & 1 & 1 & 0 & 1 ,\end{matrix}$$

is applied to an input device 40. The tuples from the input device pass to a horizontal thermocoder 42 where the tuples are horizontally thermocoded (e.g. to the left) to yield:

$$\begin{matrix}HT1 & & 1 & 1 & 0 & 0 \\ HT2 & & 1 & 0 & 0 & 0 \\ HT3 & & 1 & 1 & 1 & 0 ,\end{matrix}$$

where HT1 denotes a tuple obtained by horizontally thermocoding T1 etc.

The bits from the horizontal thermocoder 42 are then passed to a vertical thermocoder 44 where the bits in vertical tuples, corresponding to the columns of an array obtained by vertically stacking the tuples HT1, HT2, HT3, are vertically thermocoded (e.g. vertically downwards) to give:

$$\begin{matrix}VHT 1 & 1 & 0 & 0 & 0 \\ VHT 2 & 1 & 1 & 0 & 0 \\ VHT 3 & 1 & 1 & 1 & 0\end{matrix} ,$$

where the prefix “V” denotes a vertical thermocode operation and correspondingly the prefix “VH” denotes an orthogonal thermocode operation. At this stage, the tuples have been rearranged or orthogonally thermocoded as in the embodiment of FIG. 1. However in this further embodiment of FIG. 9, the values of the orthogonally thermocoded tuples VHT1 to VHT3 (i.e. 1 0 0 0), (1 1 0 0), (1 1 1 0) are used as “tags” which are compared logically with HT1 to HT3 to determine the respective mappings, with the resulting comparison being used to select the corresponding input tuple T1 to T3.

In the above example, the vertical thermocoding has been done downwards which mean that VHT2 corresponds to the weightless median and VHT1 and VHT3 correspond to the lowest and highest outliers respectively. To determine the lowest outlier, VHT1's tag is 1 0 0 0 in this example. This tag (1 0 0 0) is compared with HT1 to HT3 and here corresponds to HT2, and HT2 selects T2, i.e. (0 1 0 0) Similarly for the median, VHT2's tag is (1 1 0 0) which corresponds to HT1 which selects T1 i.e. (0 1 0 1). For the highest outlier VHT3's tag is (1 1 1 0) which corresponds to HT3 which selects T3 i.e. (1 1 0 1).

To implement this, the results of the horizontal thermocoding by the horizontal thermocoder 42 and the results of the vertical thermocoding at the vertical thermocoder 44 pass to a tag compare module 46 which performs the tag comparison described above and outputs to a pattern select module 48 a select signal which selects from the original non-thermocoded input pattern the lower outlier (referred to as new T1), the median having the median Hamming value (referred to as New T2) and the highest outlier (referred to as New T3). Although in this example (and in the circuits of FIGS. 10 to 12) only three input and three output tuples are provided, it will be immediately apparent to one skilled in the art that the technique may easily be expanded to process larger numbers of input tuples and to provide an output in which the tuples are ordered according to their Hamming values, with the original patterns in the tuples preserved.

In this illustrated example the output from the pattern select module 48 is thus:—

$$\begin{matrix}New T 1 = \begin{matrix}0 & 1 & 0 & 0 & ( outlier with lower Hamming value )\end{matrix} \\ New T 2 = \begin{matrix}0 & 1 & 0 & 1 & ( median )\end{matrix} \\ New T 3 = \begin{matrix}1 & 1 & 0 & 1 & ( outlier with highest Hamming value )\end{matrix}\end{matrix} ,$$

although the technique could be pruned to generate one, or more, or all the outliers or medians.

FIGS. 10 to 12 are logic diagrams of Boolean logical implementations of the tag compare module 46 and the pattern select module 48 of FIG. 9. In this example three operations are performed in parallel using three generally similar arrangements to determine the lowest outlier tuple T1, the weightless median T2, and the highest outlier tuple T3, using the dedicated logic circuits in FIGS. 10, 11 and 12 respectively. Each logic circuit receives the output bits from the entire result of the thermocoding by the horizontal thermocoder 42, and a respective one of the rows of the bits from the result of the thermocoding by the vertical thermocoder 44.

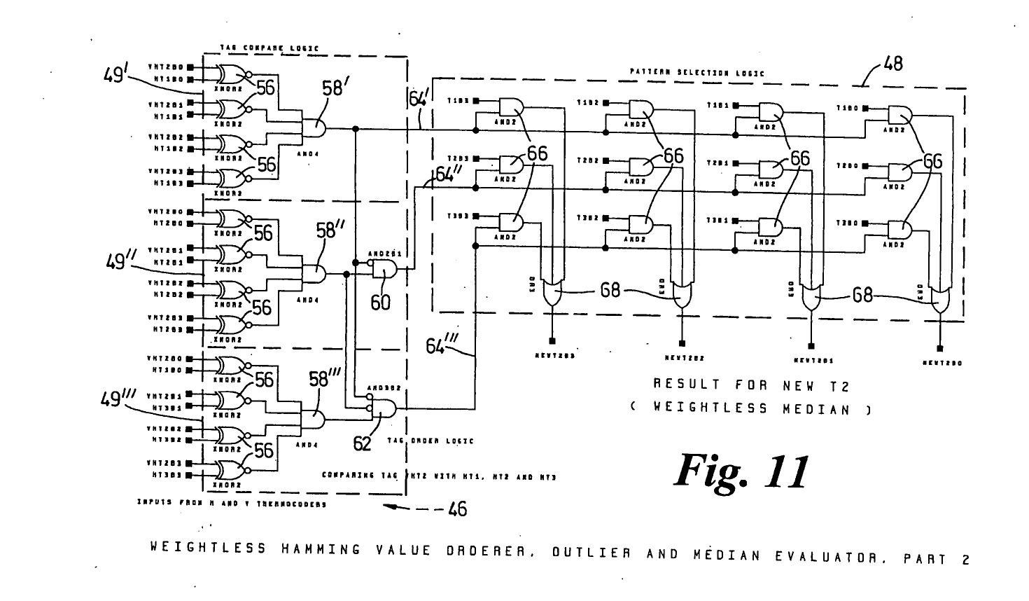

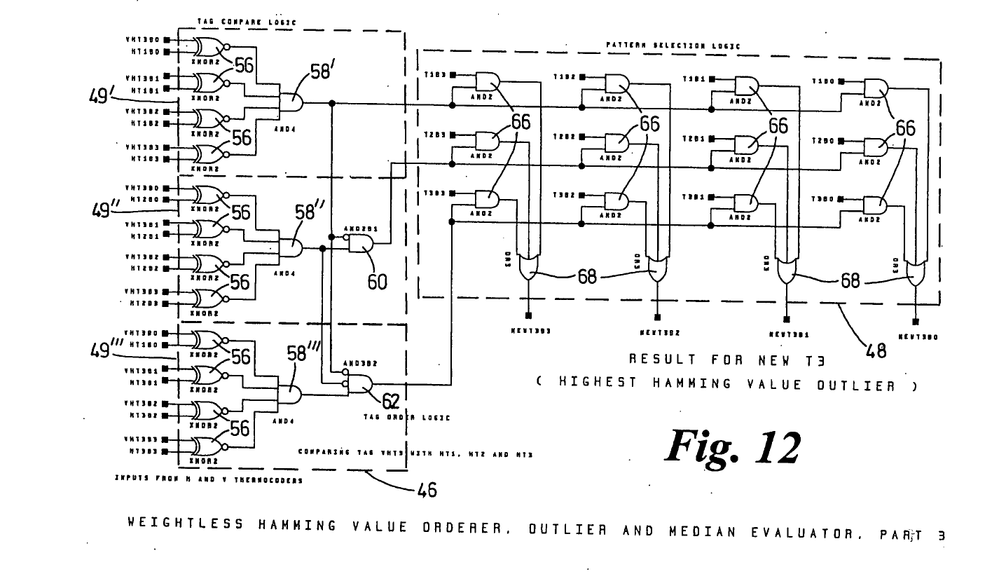

Referring initially to FIG. 10, at the foot thereof is shown the coordinate system for identifying the bits in the tuple input pattern 50, the horizontal thermocoding output pattern 52, and the vertical thermocoding output pattern 54, and this coordinate system is used in FIGS. 11 and 12 also.

Each tag compare module 46 in the three circuits comprises three sub modules 49, 49″ and 49′″, each of which comprises four 2-input EXNOR gates 56, the outputs of which are passed to a respective 4-input AND gate 58′, 58″ and 58′″. The outputs from the AND gates 58′ to 58′″ are prioritised by a two input AND gate 60 with the input from the first sub module 49′ inverted, and a three input AND gate 62 with the inputs from the sub modules 41′ and 49″ inverted, such that a high output from the first AND gate 58′ ensures that the outputs from the second and third AND gates 58″ and 58′″ are inhibited, and likewise a high output from the second AND gate 58″ inhibits the output from the third AND gate 58′″.

Consequently the output of each tag compare module 46 is a single ‘1’ on one of the three output lines 64′ to 64′″ thereof, which is passed to the associated pattern select module 48 to select a corresponding one of the input tuples. Each pattern select module 48 is made up of a 4×3 array of AND gates 66 each of which receives a corresponding bit from the input pattern 50 (i.e. the three 4-bit tuples T₁ to T₃ in this example), with the input lines 64′, 64″ and 64′″ connected to respective rows of the AND gates. The outputs from each of the columns of the AND gates are ORed together by respective OR gates 68, such that a logic 1 on one of the lines 64′, 64″ and 64′″ selects that row which is presented on the output of the OR gates 68.

The tag compare module 46 of FIG. 10 determines the lowest outlier. The first sub module 49′ compares bitwise the bits of the first row of the output of the vertical thermocoder (i.e. VHT1) with the bits of the first row of the output of the horizontal thermocoder (i.e. HT1). The second sub module 49″ compares VHT1 with HT2, and the third submodule 49′″ compares VHT2 with HT3.

The tag compare modules 46 of FIGS. 10 and 11 are generally similar except in FIG. 10, the submodules 49′, 49″, 49′″ compare the second row of the output of the vertical thermocoder i.e. VHT2 with HT1, HT2 and HT3 respectively and in FIG. 12 the submodules 49′, 49″, 49′″ compare the third row of the vertical thermocoder, i.e. VHT3 with HT1, HT2 and HT3 respectively.

Thus the outputs from the circuits of FIGS. 10 to 12 may be reassembled to provide a bit pattern corresponding to the input bit pattern reordered according to the Hamming values of the input tuples.

This embodiment deals automatically with cases where several or all the bit patterns are the same. It will be appreciated that the architecture is readily extensible in terms of the numbers of tuples and bit width. The number of tuples does not have to be odd. The implementation is entirely asynchronous.

This technique preserves the original bit patterns and their Hamming value ratings (ordering) but does not always preserve their order. For example

$$\begin{matrix}1 & 0 & 1 & 1 \\ 0 & 1 & 0 & 1 \\ 1 & 0 & 1 & 0 \\ 0 & 1 & 0 & 0\end{matrix} may yield \begin{matrix}1 & 0 & 1 & 1 \\ 1 & 0 & 1 & 0 \\ 0 & 1 & 0 & 1 \\ 0 & 1 & 0 & 0\end{matrix}$$

1. A method of treating an input set of weightless binary thermometer code tuples (t1 to t5) each with the set bits grouped at a given end of each tuple, to order the Hamming values of said weightless binary thermometer code tuples, which comprises performing an orthogonal thermocoding operation equal or corresponding to one in which:
(i) the set of weightless binary thermometer code tuples is assembled into a matrix with said weightless binary tuples stacked in a given direction (e.g. vertically) to define a set of orthogonal tuples (c1 to c6) each extending in said given direction (e.g. vertically) and each made up of a bit taken from each of said weightless binary tuples at a respective bit position, and
(ii) each of said orthogonal tuples (c1 to c6) is subjected to a thermocoding step to group the set bits at a given end of each tuple,
thereby to order the Hamming values of said weightless binary thermometer code tuples.

2. A method of treating an input set of weightless binary tuples (t1 to t5) to order the Hamming values of said weightless binary tuples, which comprises performing a thermocoding operation on each of said weightless binary tuples (t1 to t5) to group the set bits at a given end of each tuple to provide a set of weightless binary thermometer code tuples, and thereafter performing an orthogonal thermocoding operation corresponding to one in which:
(i) the set of weightless binary thermometer code tuples is assembled into a matrix with said weightless binary tuples stacked in a given direction (e.g. vertically) to define a set of orthogonal tuples (c1 to c6) each extending in said given direction (e.g. vertically) and each made up of a bit taken from each of said weightless binary tuples at a respective bit position, and
(ii) each of said orthogonal tuples (c1 to c6) is subjected to a thermocoding step to group the set bits at a given end of each tuple,
thereby to order the Hamming values of said weightless binary tuples.

3. A method according to claim 1, wherein the input set (t1 to t5) comprises an odd number of tuples, and which further comprises determining the median of said set by identifying the central value of said ordered Hamming values.

4. A method according to claim 1 wherein the input set comprises an even number (2n) of tuples, and which further comprises determining a median by identifying in said ordered set of Hamming value a value corresponding to one of the n^{th} or the (n+1)^{th} values.

5. A method according to claim 1 wherein the input set comprises an even number (2n) of tuples, and which further comprises determining a median of said set by introducing a further tuple into said set before performing said orthogonal thermocoding operation so that the set comprises an odd number of tuples.

6. A method according to claim 5, wherein said further tuple is produced by duplicating one of the other tuples in said input set.

7. A method according to claim 1, which further comprise determining at least one weightless outlier value by determining at least one of the first and last of said ordered Hamming values.

8. A method of applying a filtering operation to a two- or higher-dimensional array of tuples, which comprises:
performing the method of any of the preceding claims on a set of values in a predetermined window in said array in a filtering step,
using at least a selected one of said ordered Hamming values as the filtered result of said filtering step, and
incrementing said window relative to said array, to provide a series of filtered results.

9. A method according to claim 8, wherein for each filtering step, a median Hamming value is taken as the filtered result.

10. A method according to claim 8, wherein said array of tuples is two-dimensional and represents a two-dimensional image.

11. A method according to claim 8, wherein said array of tuples is three-dimensional and represents a three dimensional volume.

12. A method according to claim 1 wherein, having ordered the Hamming values of said weightless binary tuples, and after said orthogonal thermocoding operation, the bit pattern of at least one of said tuples corresponding to a given ranking is compared to the bit patterns of the tuples before said orthogonal thermocoding operation to identify an or the equivalent tuple thereto, and the location of said equivalent tuple is used to determine a corresponding input tuple, thereby to identify or present the input tuple with said given ranking.

13. A method according to claim 12, wherein the bit patterns of all of the tuples after said orthogonal coding operation are compared to the bit patterns of the tuples before said orthogonal thermocoding operation thereby to identify equivalents to each thereof and thereby to identify a ranking of each of said input tuples.

14. A method according to claim 13, wherein said comparison is done asynchronously and in parallel.

15. A method of filtering a stream of weightless binary tuples comprises selecting from said stream a plurality of sample tuples and applying to said sample tuples a method according to claim 1, to order the Hamming values of said tuples and selecting at least one of the Hamming values according to its order and ouputting said selected Hamming value as the filtered output.

16. A method according to claim 15, which comprises selecting a median Hamming value for the filtered output.

17. Apparatus for treating an input set of weightless binary thermometer code tuples (t1 to t5) with the set bits grouped at a given end of each tuple, thereby to order the Hamming value of said weightless binary thermometer code tuples, said apparatus comprising:
transformation means (14) for performing an orthogonal thermocoding operation corresponding to one in which:
(i) the set of weightless binary thermometer code tuples is assembled into a matrix with said weightless binary tuples stacked in a given direction (e.g. vertically) to define a set of orthogonal tuples (c1 to c6) each extending in said given direction (e.g. vertically) and each made up of a bit taken from each of said weightless binary tuples at a respective bit position, and
(ii) each of said orthogonal tuples (c1 to c6) is subjected to a thermocoding step to group the set bits at a given end of each tuple,
thereby to order the Hamming values of said weightless binary thermometer code tuples.

18. Apparatus for treating an input set of weightless binary tuples, which comprises:
first stage thermocode converter means (12) for converting each of said weightless binary tuples into a weightless binary thermometer code tuple to provide a set thereof, and
transformation means (14) for performing an orthogonal thermocoding operation corresponding to one in which:
(i) the set of weightless binary thermometer code tuples is assembled into a matrix with said weightless binary tuples stacked in a given direction (e.g. vertically) to define a set of orthogonal tuples each extending in said given direction (e.g. vertically) and each made up of a bit taken from each of said weightless binary tuples at a respective given bit position, and
(ii) each of said orthogonal tuples is subjected to a thermocoding step to group the set bits at a given end of each tuple,
thereby to order the Hamming values of said weightless binary thermometer code tuples.

19. Apparatus according to claim 18, wherein said first stage thermometer code converter means (12) comprises respective thermometer code converter means (12) for each of said weightless binary tuples making up the input set.

20. Apparatus according to claim 17, wherein said transformation means includes orthogonal tuple defining means for defining a set of orthogonal tuples (c1 to c6), each said orthogonal tuple being made up of bits taken from a respective bit position of said weightless binary thermometer code tuples, and respective thermometer coding means (14) for thermocoding each of said orthogonal tuples.

21. Apparatus according to claim 20, including means for analysing a matrix made up of said thermocoded orthogonal tuples to determine the or a central tuple (16) orthogonal to said orthogonal tuples, said central tuple (16) representing to the median Hamming value of said weightless binary thermometer code tuples.

22. Apparatus according to claim 19, including means for analysing a matrix made up of said thermocoded orthogonal tuples to determine at least one of the first (18) and the last (20) of said orthogonal set of tuples, which represents at least one outlier.

23. Apparatus according to claim 19, wherein at least one of thermometer coding means (12, 14) comprises an asynchronous thermometer coding means (22) using a modular structure (26).

24. Apparatus according to claim 19, wherein at least one of the thermometer coding means (14) comprises a pipelined synchronous thermometer coding means.

25. Apparatus for treating an input set of weightless binary thermometer code tuples (t1 to t5) each with the set bits grouped at a given end of the tuple, said apparatus comprising:
respective thermometer code converter means (14) for each bit position of the input tuples, each thermometer coding means (14) receiving a bit from each of the weightless binary thermometer code tuples and performing a thermometer coding operation on said bits, collectively to apply an orthogonal coding operation on said weightless binary tuple code tuples, to provide a set of orthogonally thermocoded tuples (c1 to c6), which when assembled side-by-side in a matrix make up, an ordered set of tuples representing the Hamming value of said weightless binary thermometer code tuples.

26. Apparatus for treating an input set of weightless binary tuples (t1 to t5) which comprises:—
respective first stage thermometer code converter means (12) for converting each of said weightless binary tuples (t1 to t5) into a weightless binary thermometer code tuple;
respective second stage thermometer code converter means (14) for each bit position of the input tuples, each thermometer coding means receiving a bit from each of the weightless binary thermometer code tuples and performing a thermometer coding operation on said bits, collectively to apply an orthogonal coding operation on said weightless binary tuple code tuples, to provide a set of orthogonally thermocoded tuples (c1 to c6), which, when assembled in a matrix, make up in the direction orthogonal to said orthogonally thermocoded tuples (c1 to c6), an ordered set of tuples representing the Hamming value of said input weightless binary thermometer code tuples (t1 to t5).

27. Apparatus according to claim 17, which includes bit pattern comparison means for comparing the bit pattern, after said orthogonal thermocoding step, of at least one of said tuples corresponding to a given Hamming value ranking, with each of the bit patterns of the tuples before said orthogonal thermocoding operation to determine an equivalent thereto, and
pattern selection means responsive to said bit pattern comparison means to output a tuple having a bit pattern identical to that of the input tuple with said given Hamming value ranking.

28. Apparatus according to claim 25, wherein said bit pattern comparison means comprises respective logic modules (49′, 49″, 49′″) each for comparing the bit pattern of a given single tuple (VHT1, VHT2 or VHT3) resulting from said orthogonal coding step with a respective one of the tuples input to said orthogonal thermocoding step (HT1, HT2 and HT3).

29. Apparatus according to claim 26, wherein said apparatus further includes respective logic modules (49′, 49″, 49′″) each for comparing the bit patterns of the remaining tuples (VHT1, VHT2, VHT3) resulting from said orthogonal coding step with the tuples input to said orthogonal thermocoding step (HT1, HT2, HT3).

30. A filter for filtering a stream of weightless binary tuples comprising input means (32) for selecting from an input stream of weightless tuples a predetermined plurality of sample tuples and for supplying said sample tuples to apparatus (36) according to claim 15 to order the Hamming values of said weightless tuples, and selection means (36) for selecting at least one of said Hamming values according to its order and for outputting said selected Hamming value as the filtered output.

31. A filter according to claim 30, wherein said input means comprises a plurality of sample holding registers (32) arranged in series and clock means (34) for clocking said stream of weightless tuples through said registers (32).

32. A filter according to claim 30, wherein said selection means (36) selects a Hamming value having a median Hamming value for the filtered output.

33. A filter according to claim 30, for filtering data representing a two dimensional image, wherein said selection means comprises a plurality of sample holding registers (32), line delay means and clock means for defining a rolling filter window.
